(19) United States
(12) Patent Application Publication
(10) Pub. No.: US 2007/0031754 A1
(43) Pub. Date: Feb. 8, 2007

(54) Kneading and pulverizing method and apparatus for producing a toner, and a mixture for use in the method and apparatus

(76) Inventors: Fumitoshi Murakami, Fuji-shi (JP); Nobuyasu Makino, Numazu-shi (JP); Makoto Hirai, Fuji-shi (JP); Mutsumi Takahashi, Numazu-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/510,673

(22) Filed: Aug. 28, 2006

Related U.S. Application Data
(62) Division of application No. 10/848,062, filed on May 19, 2004.

(30) Foreign Application Priority Data
May 19, 2003 (JP) 2003-140977

(51) Int. Cl. G03G 5/00

(52) U.S. Cl. 430/137.19

(57) ABSTRACT

A mixture including at least a binder resin and a colorant and a kneader configured to knead such a mixture. The mixture may include air bubbles having a density from 104 to 108 pieces/cm³ and constituting from 65 to 95% of said mixture by volume. The kneader may be configured to knead the mixture under pressure upon application of heat to the mixture to prepare a kneaded mixture.

### CROSS REFERENCE TO RELATED APPLICATIONS

This application is a divisional of U.S. application Ser. No. 10/848,062, filed May 19, 2004, and is based upon and claims the benefit of priority from the prior Japanese Patent Application No. 2003-140977 filed on May 19, 2003, the entire contents of each of which are incorporated herein by reference.

### BACKGROUND OF THE INVENTION

1. Field of the Invention

The present invention relates to a kneading and pulverizing method and a kneading and pulverizing apparatus for producing a toner for electrophotography, and to a mixture for use in the method and apparatus.

2. Description of the Background Art

As for recent images formed by electrophotographic processes, the number of graphic images such as photographs increases in addition to productions of conventional letter prints because of digitalization, and popularization of networks and computers. The image is required to have a quality equivalent to that of a silver salt photograph, and therefore a toner for electrophotography is required to have a small particle diameter of from 5 to 6 μm and a narrow distribution. Accordingly, a method of efficiently producing the toner is desired.

As one of the methods, a polymerization method has recently been used. However, the method requires a large amount of water and solvent, although it produces less carbon dioxide than conventional production methods, including kneading, pulverizing, classifying, mixing and sieving processes. Further, the method requires a huge plant and the initial cost is so large that the method is unprofitable unless mass-producing the toner. Therefore, the method has rather an expensive production cost.

However, a pulverizer in the conventional production methods, including kneading, pulverizing, classifying, mixing and sieving processes, pulverizes the toner so as to have a small particle diameter, but an enormous amount of energy is consumed. Further, ultra-fine particles are produced due to an excessive pulverization, resulting in large deterioration of productivity.

These problems result in increase of production cost of the toner, and therefore various improvements such as an improvement of pulverizing efficiency are being studied.

The improvements include a method of including a pulverizing aid in toner materials to improve pulverizability of the same when kneaded in a pulverization method.

For example, Japanese Laid-Open Patent publication No. 10-207124 discloses a method of including an ester compound having a weight-average molecular weight of from 300 to 4,000 formed from a reaction between a propane diol derivative and a terephthalic acid or an isophthalic acid and a carboxylic acid derivative selected from esters of the isophthalic acid in toner materials as a pulverizing aid to improve pulverizability of the resultant toner.

However, the resultant toner has too low a molecular weight in the method and easily adheres on internal parts of a pulverizer, a classifier, and a piping to affect the product condition, chargeability, and fixability of the resultant toner.

Further, for a similar purpose, Japanese Laid-Open Patent publication No. 2001-92178 discloses a method of including a pulverizing aid to improve pulverizability of the resultant toner, which is a polymer of a monomer selected from the group consisting of vinyltoluene, α-methylstyrene and isopropenyltoluene, and which has a softening point of from 130 to 170° C. measured by a ring-and-ball test; or a copolymer between styrene and the monomer selected from the group consisting of vinyltoluene, α-methylstyrene and isopropenyltoluene, and which has a softening point of from 110 to 170° C. measured by the ring-and-ball test.

However, when actually producing the toner, 10 parts by weight of the pulverizing aid is included in 90 parts by weight of a main resin, which is so large that the aid badly affects properties of the resultant toner, such as fixability and chargeability.

Japanese Laid-Open Patent publications Nos. 1-182856, 9-146299 and 2000-19775 disclose a method of further including a chemical foaming agent in plural materials forming a toner when kneaded upon application of heat or a method of previously including and dispersing the chemical foaming agent in a binder resin; applying a heat to the binder resin to generate a carbon dioxide gas or a nitrogen gas therein to foam the binder resin; and forming a crack interface with inner air bubbles to improve pulverizing efficiency in the following process.

Specific examples of the chemical foaming agent include hydrogen carbonate of alkali metals such as sodium or calcium; a chemical foaming agent of heavy metals such as mercury or cadmium; or inorganic materials such as ammonium carbonate; and organic materials such as an azido compound, azodicarbonamide, diaminobenzene and chlorofluorocarbon 11 or 12.

Some of the chemical foaming agents are hazardous materials in handling or cause environmental contaminations. In addition, the chemical foaming agents need to be heated to be foamed, and a heat stress is given to a low-temperature fixable toner, which has recently drawn attention. Further, occasionally properties of the chemical foaming agents themselves badly affect properties of the resultant toner, such as fixability and chargeability.

Japanese Laid-Open Patent publication No. 2003-10666 discloses a method of foaming a binder resin (not for a toner) by forming a foam while preventing discoloration and carbonization of a thermoplastic resin in a kneading process, wherein carbon dioxide is included in the kneading process to form air bubbles.

When the method is applied to the production of a toner, the inactive gas tends to be unevenly dispersed in melted resins. Although not badly affecting the toner qualities, air bubbles have a ratio of at most 60 % by volume in the resins. Therefore, the method can exert an effect on pulverizability of the resultant toner at most to half, and does not exert a sufficient effect on the pulverizability of the resultant toner so as to have a required particle diameter of from 5 to 6 μm.

Japanese Patent No. 2625576 discloses a method of producing foams and foaming plastics having quite small-sized air bubbles by using a supercritical fluid.

The above-mentioned background foaming methods using the chemical foaming agents deteriorates strength of the resultant foams although being capable of saving weight of foaming resins, and applications of the foams are limited. However, the microscopic air bubble foaming technology (MCF: Micro Cellular Foaming) disclosed in Japanese Patent No. 2625576 using the supercritical fluid developed by MIT in the U.S. is capable of producing a resin wherein microscopic air bubbles having a size of 5 μm or less are uniformly formed.

This method specifically foams a single polymer material to finally produce a foamed material or product having a small-sized air bubbles. However, the toner for electrophotography includes not only a binder resin but also other materials such as a colorant. Further, a kneaded mixture formed of plural materials and prepared in a process of producing the toner is further pulverized to form the final toner, and therefore the method disclosed in Japanese Patent No. 2625576 cannot directly be applied to production of the toner for electrophotography.

In addition, even if air bubbles having a density of 109/cm³ and a size of 5 μm or less are formed in the kneaded mixture, the pulverizability of the resultant toner is not largely improved, and an ultrafine powder is generated to impair an improvement of yield.

### SUMMARY OF THE INVENTION

Because of these reasons, the present inventors realized a need exists for a method of producing a toner for electrophotography by kneading and pulverizing methods, which improves pulverizability of a kneaded mixture and prevents an ultrafine powder from being generated.

Accordingly, an object of the present invention is to provide a novel method and a novel apparatus for producing a toner by kneading and pulverizing methods, which improves pulverizability of a kneaded mixture and prevents an ultrafine powder from being generated.

Another object of the present invention is to provide a novel toner for electrophotography including less ultrafine powders.

Briefly these objects and other objects of the present invention as hereinafter will become more readily apparent can be attained by a method of producing a toner including at least a binder resin and a colorant including kneading a mixture comprising the binder resin and the colorant under pressure while injecting a supercritical fluid into the mixture upon application of heat to uniformly disperse the supercritical fluid in the mixture; depressurizing the mixture such that the mixture foams; cooling the mixture to prepare a kneaded mixture including air bubbles; and pulverizing the kneaded mixture.

In addition, the supercritical fluid is preferably carbon dioxide or nitrogen, and the pressure is preferably from 4 to 25 MPa.

Further, the mixture is preferably kneaded at a temperature of from 10° C. lower than a melting point of a toner to 100° C. higher than the melting point thereof or from 30° C. lower than a glass transition temperature thereof to 150° C. higher than the glass transition temperature thereof.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a foaming kneader for use in the present invention;

FIG. 2 is a macrophotograph showing a status of formation of air bubbles in toner constituents after foamed and kneaded; and

FIG. 3 is a macrophotograph showing a crushed status of the foamed and kneaded toner constituents (having a weight-average particle diameter not greater than 60 μm) in FIG. 2.

### DETAILED DESCRIPTION OF THE PREFERRED EMBODIMENTS

Generally, the present invention provides a method of producing a toner including injecting a supercritical fluid into a mixture comprising a binder resin and a colorant under pressure while kneading the mixture upon application of heat to uniformly disperse the supercritical fluid in the mixture; depressurizing the mixture to foam the mixture; cooling the mixture to prepare a kneaded mixture including air bubbles; and pulverizing the kneaded mixture.

Namely, the method of producing a toner for electrophotography of the present invention mixes materials forming the toner such as a binder resin and a colorant (hereinafter referred to as toner constituents) to prepare a mixture; injects and disperses a supercritical fluid in the mixture, and pressurizes the mixture; and depressurizes the mixture to quickly foam the mixture and form a crack interface of an inner air bubble and an air bubble film. The kneaded mixture having the crack interface can efficiently be pulverized to small-sized particles and the resultant toner has a satisfactory quality through the production process.

The above-mentioned pressurizing and depressurizing are relative to each other, and e.g., the pressure can be reduced to atmospheric pressure.

The method can form air bubbles having a particle diameter of from 20 to 200 μm and does not form air bubbles having a micro diameter, and therefore, production of an ultrafine powder having a particle diameter of 2 μm or less can be prevented.

The supercritical fluid has a smaller viscosity than a gaseous body although having a high density, and has a diffusion coefficient almost several hundred times the diffusion coefficient of a gaseous body. Therefore, air bubbles formed by the supercritical fluid have uniform diameters, which is largely different from that of conventional foaming using a gaseous body. When the supercritical fluid is used in the method of producing a toner of the present invention, a crack interface formed between an air bubble formed in a film of the kneaded mixture having a thickness of from 2 to 15 μm and an inner air bubble can noticeably improve pulverizability of the resultant toner.

Hereinafter, to separate a final product, i.e., a toner after pulverized from a mixture or a kneaded mixture of plural toner materials, the mixture or kneaded mixture thereof is referred to as toner constituents.

In particular, carbon dioxide or nitrogen in a supercritical state is effectively used as the supercritical fluid in the present invention.

Specific examples of the chemical foaming agents for foaming and kneading the toner constituents include low-boiling-point chlorofluorocarbon, a hydrofluorocarbon compound, propane, butane, carbon hydride, etc. However, these agents occasionally affect quality of the resultant toner badly, and are occasionally dangerous in handling or occasionally contaminate the environment.

The method of using the carbon dioxide or nitrogen as the supercritical fluid does not cause quality problems in the resultant toner and is safe and favorable for the environment.

Particularly, carbon dioxide is easy to care for, has low toxicity, and is low cost. In addition, an apparatus capable of supplying a fixed amount of carbon dioxide is prevalent in the market, and the apparatus can easily be obtained or prepared. However, the supercritical fluid is not limited to carbon dioxide.

In the method of producing a toner of the present invention, the supercritical fluid is put into a kneader, wherein the supercritical fluid is injected and dispersed in melted toner constituents, particularly in a resin under pressure and the fluid in the toner constituents, particularly in the resin is quickly foamed under reduced pressure to form air bubbles in a kneaded mixture. When the pressure is too high, the air bubbles burst. When the pressure is too low, the air bubbles cannot be formed in the resin. Therefore, the pressure is preferably from 4 to 25 MPa, and more preferably from 7 to 11 MPa.

To uniformly inject and disperse the supercritical fluid in melted toner constituents, the melted toner constituents preferably have a temperature not too much higher or too much lower than a melting point or a glass transition point thereof. When the temperature is too low, air bubbles have small diameters and an air bubble film is too thick. When the temperature is too high, air bubbles have large diameters and an air bubble film is too thin.

The temperature is preferably from −10 to +100° C. from a melting point of the kneaded mixture formed from the toner constituents or from +30 to +150° C. from a glass transition temperature thereof. More preferably from −5 to +150° C. and +40 to +100° C. respectively.

The supercritical fluid is preferably injected into the toner constituents in an amount of from 0.5 to 10% by weight, and more preferably not greater than 5% by weight based on total weight of resins included in the toner constituents.

In consideration of pulverizability and prevention of generation of an ultrafine powder, the kneaded mixture including the toner constituents and supercritical fluid preferably has air bubbles of from 104 to 108 pieces/cm³ in the resin and 65 to 96% by volume therein, and more preferably from 106 to 107 pieces/cm³ and 85 to 95% by volume.

When the number of the air bubbles is small and the percentage by volume is large, the volume of the toner constituents increases to become difficult to handle, and pulverizability of the resultant toner tends to deteriorate. Even when the number of the air bubbles is large and the percentage by volume is small, the pulverizability does not improve.

The number and volume of the air bubbles can be controlled by an injection amount of the supercritical fluid, a temperature and a pressure of the melted toner constituents.

The air bubbles particularly formed in the resin in the kneaded mixture preferably have a thickness of from 4 to 7 μm.

When the thickness is too thin, the proportion of ultrafine powders increases. When too thick, the pulverizability of the resultant toner tends to deteriorate.

Either a biaxial kneader or a uniaxial kneader can be used for preparing the kneaded mixture. Specific examples of the biaxial kneader include known same-direction biaxial rotational extruders such as TEM series from Toshiba Machine Co., Ltd and TEX series from Japan Steel Works, Ltd.

A ring die or a T die used for forming a foamed sheet is preferably used to foam the toner constituents to form air bubbles therein. Even a simple ring nozzle can foam the toner constituents.

Conventionally, the melted toner constituents are kneaded and discharged in the shape of a stick or a plate, and cooled and extended by an extension cooler to have the shape of a sheet. Then, the cooled and extended toner constituents are pulverized.

However, in the present invention, the toner constituents can be cooled by an adiabatic expansion that occurs in the process of forming air bubbles in the toner constituents. Then, the toner constituents can be quickly cooled to have a temperature of 30° C. or less by a simple cold blaster, and therefore the conventional extension cooling process can be omitted. Further, the quick cooling can uniformly disperse and fix a colorant, a charge controlling agent, wax, etc. in a binder resin to form a quality toner.

A continuous kneader equipped with an injection and dispersion zone of the supercritical fluid can foam and knead the toner constituents.

In addition, after the toner constituents are kneaded upon application of heat by a continuous kneader, the toner constituents can be fed by a volumetric feeder to a parallel formed foaming kneader having an injection and dispersion zone of the supercritical fluid to be foamed.

Further, the pulverized toner constituents after kneading, extending, and cooling can be fed to a foaming kneader having an injection and dispersion zone to be melted again and foamed.

The above-mentioned methods can be used for foaming and kneading the toner constituents.

A variety of arrangement of the present kneaders can be realized, such as TCS series from Buss AG, TEM series from Toshiba Machine Co., Ltd and TEX series from Japan Steel Works, Ltd.

The kneaded mixture including air bubbles, prepared by the method of the present invention can easily be pulverized by a mechanical pulverizer to form a desired toner having a volume-average particle diameter not greater than 12 μm. Namely, the pulverizing method of producing a toner of the present invention foams a kneaded mixture and forms a crack interface therein with inner air bubbles to improve pulverizability of the resultant toner. Specific examples of the mechanical pulverizer include TURBO MILL® from TURBO KOGYO CO., LTD., INOMIZER® from Hosokawa Micron Corp., Kryptron® from Kawasaki Heavy Industries, Ltd. and Fine Mill from Nippon Pneumatic Mfg. Co., Ltd., etc.

Further, an air (et) stream pulverizer can prepare a toner having a weight-average particle diameter of from 4 to 6 μm. Specific examples of the air stream pulverizer include IDS-type supersonic jet mill® from Nippon Pneumatic Mfg. Co., Ltd., fluidized-bed counter jet mill® from Hosokawa Micron Corp., cross jet mill® from KURIMOTO, LTD. and CGS-type jet mill® from Condux International, Inc., etc.

Next, the toner constituents of the present invention will be explained. Known binder resins and colorants can be used in the toner of the present invention.

Specific examples of the binder resin for use in the toner of the present invention include vinyl resins, polyester resins or polyol resins. Particularly, the polyester resins or polyol resins are preferably used.

Specific examples of the vinyl resins include polymers of styrene and its substitutes such as polystyrene, poly-p-chlorostyrene and polyvinyltoluene, styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-acrylonitrile-indene copolymers, styrene-maleate copolymers and styrene-ester maleate copolymers, polymethyl methacrylate, polyvinyl chloride, polyvinyl acetate, etc.

Specific examples of the polyester resins include the polyester resins constituted of one or more of the following dihydric alcohols in group A and one or more of the dibasic acids in group B and optionally one or more of the following alcohols having not less than 3 hydroxyl groups or carboxylic acids of Group C.

Group A: ethylene glycol, triethylene glycol, 1,2-propylene glycol, 1,3-propylene glycol, 1,4-butane diol, neopentyl glycol, 1,4-butene diol, 1,4-bis(hydroxymethyl)cyclohexane, bisphenol A, hydrogenated bisphenol A, polyoxyethylenated bisphenol A, polyoxypropylene-(2,2)-2,2′-bis(4-hydroxyphenyl)propane, polyoxypropylene-(3,3)-2,2-bis(4-hydroxyphenyl)propane, polyoxyethylene-(2,0)-2,2-bis(4-hydroxyphenyl)propane, polyoxypropylene-(2,0)-2,2′-bis(4-hydroxyphenyl)propane, etc.

Group B: maleic acid, fumaric acid, mesaconic acid, citraconic acid, itaconic acid, glutaconic acid, phthalic acid, isophthalic acid, terephthalic acid, cyclohexane dicarboxylic acid, succinic acid, adipic acid, sebacic acid, malonic acid, a linolenic acid or their anhydrides, or esters thereof with lower alcohols, etc.

Group C: alcohols having not less than 3 hydroxyl groups such as glycerin, trimethylolpropane and pentaerythritol, and carboxylic acids having not less than 3 carboxyl groups such as trimellitic acid and pyromellitic acid.

Specific examples of the polyol resins include reaction products of the following components:

an epoxy resin;

an adduct of a dihydric phenol compound with an alkylene oxide or its glycidyl ether compound;

a compound having one active hydrogen atom reactive with the epoxy resin; and

a compound having two or more active hydrogen atoms reactive with the epoxy resin.

Further, epoxy resins, polyamide resins, urethane resins, phenol resins, butyral resins, rosins, denatured rosins, terpene resins, etc. can optionally be added to the above-mentioned resins.

Specific examples of the black pigments for use in the present invention include azine pigments such as carbon black, oil furnace black, channel black, lamp black, acetylene black and aniline black, metal salts of azo pigments, metal oxides, complex metal oxides, etc.

Specific examples of the yellow pigments for use in the present invention include cadmium yellow, Mineral Fast Yellow, Nickel Titan Yellow, naples yellow, Naphthol Yellow S, Hansa Yellow G, Hansa Yellow 10G, Benzidine Yellow GR, Quinoline Yellow Lake, Permanent Yellow NCG, Tartrazine Lake, etc.

Specific examples of the orange color pigments for use in the present invention include Molybdenum Orange, Permanent Orange GTR, Pyrazolone Orange, Vulcan Orange G, Indanthrene Brilliant Orange GK, etc.

Specific examples of the red pigments for use in the present invention include red iron oxide, cadmium red, Permanent Red 4R, Lithol Red, Pyrazolone Red, Watching Red calcium salts, Lake Red D, Brilliant Carmine 6B, Eosine Lake, Rhodamine Lake B, Alizarine Lake, Brilliant Carmine 3B, etc.

Specific examples of the violet pigments for use in the present invention include Fast Violet B, Methyl Violet Lake, etc.

Specific examples of the blue pigments for use in the present invention include cobalt blue, Alkali Blue, Victoria Blue Lake, Phthalocyanine Blue, metal-free Phthalocyanine Blue, partially chlorinated Phthalocyanine Blue, Fast Sky Blue, Indanthrene Blue BC, etc.

Specific examples of the green pigments for use in the present invention include a chrome green, chrome oxide, Pigment Green B, Malachite Green Lake, etc.

These pigments can be used alone or in combination, and typically included in the toner in an amount of from 0.1 to 50 parts by weight per 100 parts by weight of the binder resin.

To impart a releasability to the toner, known release agents, e.g., synthesized waxes such as low-molecular-weight polyethylene and low-molecular-weight polypropylene; and natural waxes such as carnauba wax, rice wax and lanoline can be used.

A charge controlling agent can be used in the toner of the present invention. Specific examples of the charge controlling agent include known charge controlling agents such as nigrosin, modified fatty acid metal salts, acetylacetone metal complexes, mono azo metal complexes and naphtoic acids.

The toner of the present invention may be a magnetic toner. Specific examples of the magnetic material include known magnetic materials, e.g., iron oxides such as magnetite and hematite.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

100.0 parts of polyol resin, 6.0 parts of quinacridone magenta pigment (C.I. Pigment Red122) and 2.0 parts of zinc salicylate salt as a charge controlling agent were mixed by Super Mixer® from KAWATA MFG Co., Ltd.

After the mixture was fed from a constant-flow feeder (2) into a hopper (3) in a biaxial kneader TEM® (1) from Toshiba Machine Co., Ltd., the mixture was melted upon application of heat at 140° C. in a melting zone (4), and kneaded and dispersed in a kneading zone (5) of the biaxial kneader. Then, a supercritical fluid was put in the mixture and dispersed in a supercritical fluid injection and dispersion zone (6).

Respective zones of the kneader had different pressures, e.g., the melting zone (4) had an atmosphere pressure and the supercritical fluid injection and dispersion zone (6) had a pressure of 15 MPa.

A carbon dioxide in a supercritical state was used as the supercritical fluid, which was controlled to have a pressure of 15 MPa and a temperature of 38° C. by a supercritical fluid control feeder (7), and injected to and dispersed with the above-mentioned toner constituents melted at 140° C. in an amount of 3.0% by weight based on total weight of the toner constituents.

Next, after the toner constituents were cooled to have a temperature of 120° C. in a temperature control zone (8), the toner constituents were discharged from a ring nozzle (9) under an atmosphere pressure to be foamed. Then, the toner constituents were cooled to have a temperature not greater than 30° C. by a cold blaster (10) to prepare a kneaded mixture including the toner constituents and air bubbles.

### Example 2

The procedures for preparation of the kneaded mixture including the toner constituents and air bubbles in Example 1 were repeated except for injecting the carbon dioxide in a supercritical state in an amount of 1.5% by weight based on total weight of the toner constituents to prepare a kneaded mixture including the toner constituents and air bubbles.

### Example 3

The procedures for preparation of the kneaded mixture including the toner constituents and air bubbles in Example 1 were repeated except for injecting and dispersing the carbon dioxide in a supercritical state in the toner constituents melted at 120° C. and cooling the toner constituents to have a temperature of 90° C. to prepare a kneaded mixture including the toner constituents and air bubbles.

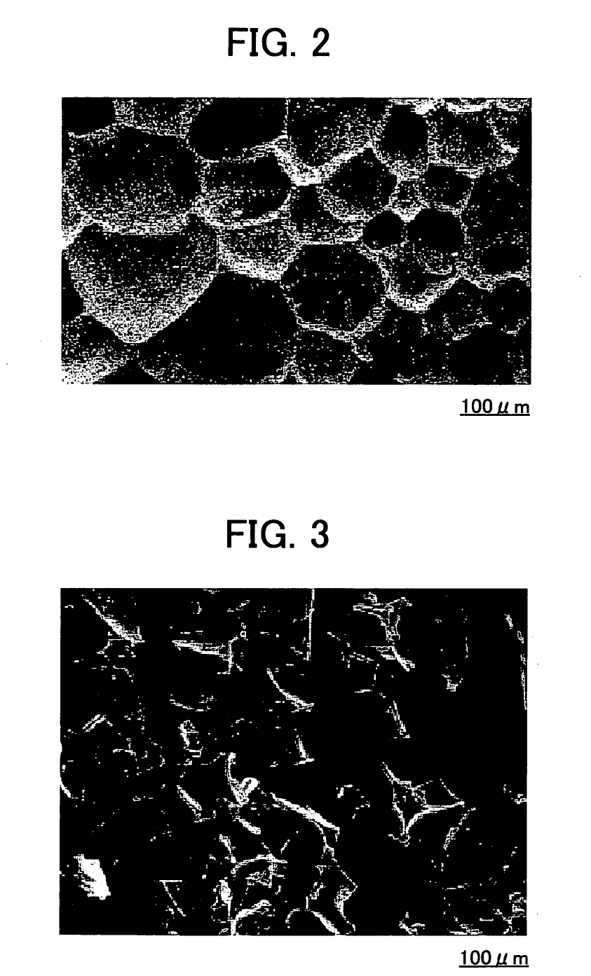

FIG. 2 shows a foamed status of the kneaded mixture including the toner constituents and air bubbles.

### Example 4

The procedures for preparation of the kneaded mixture including the toner constituents and air bubbles in Example 3 were repeated except for injecting the carbon dioxide in a supercritical state in an amount of 1.5% by weight based on total weight of the toner constituents to prepare a kneaded mixture including the toner constituents and air bubbles.

### Example 5

The procedures for preparation of the kneaded mixture including the toner constituents and air bubbles in Example 1 were repeated except for mixing 100.0 parts of polyester resin, 8.0 parts of carbon black, 4.0 parts of wax and 1.0 part of zirconium oxide complex salt as a charge controlling agent as the toner constituents to prepare a kneaded mixture including the toner constituents and air bubbles.

### Example 6

The procedures for preparation of the kneaded mixture including the toner constituents and air bubbles in Example 3 were repeated except for mixing 100.0 parts of polyester resin, 8.0 parts of carbon black, 4.0 parts of wax and 1.0 part of zirconium oxide complex salt as a charge controlling agent as the toner constituents to prepare a kneaded mixture including the toner constituents and air bubbles.

### Example 7

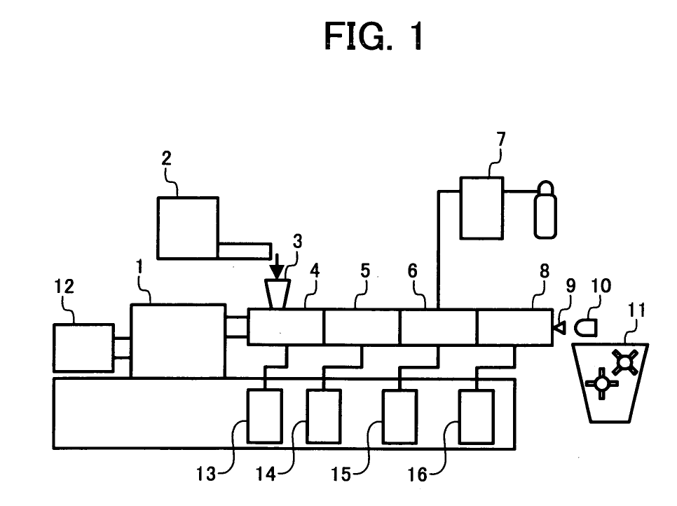

The kneaded mixture prepared in Example 3 was broken by a pin-type breaker as shown in FIG. 1, crushed by a rotational hammer crusher from Hosokawa Micron Corp. to have a weight-average particle diameter not greater than 60 μm and pulverized by a mechanical turbo mill from TURBO KOGYO CO., LTD. to prepare a toner having a weight-average particle diameter of 9.0 μm.

Next, the toner having a weight-average particle diameter of 9.0 μm was classified by a rotational rotor classifier from Hosokawa Micron Corp. to have a weight-average particle diameter of 9.8 μm. Then, 0.8 parts of hydrophobic silica and 0.4 parts of titanium oxide were mixed with the toner and an agglomerate was removed therefrom by a supersonic vibration sieve to prepare a final toner.

A status of the kneaded mixture including air bubbles which was crushed by a rotational hammer crusher is shown in FIG. 3, wherein the kneaded mixture was crushed along an interface of air bubbles.

### Comparative Example 1

100.0 parts of polyol resin, 6.0 parts of quinacridone magenta pigment (C.I. Pigment Red122) and 2.0 parts of zinc salicylate salt as a charge controlling agent were mixed by Super Mixer® from KAWATA MFG Co., Ltd.

After the mixture was fed from a constant-flow feeder (2) into a hopper (3) in a biaxial kneader TEM® (1) from Toshiba Machine Co., Ltd., the mixture was melted upon application of heat at 120° C. in a melting zone (4), and kneaded and dispersed in a kneading zone (5) of the biaxial kneader.

Next, after the toner constituents were cooled to have a temperature of 90° C. in a temperature control zone (8), the toner constituents were cooled to have a temperature not greater than 30° C. by a rolling cooler.

The kneaded mixture was broken by a pin-type breaker, crushed by a rotational hammer crusher from Hosokawa Micron Corp. to have a weight-average particle diameter not greater than 250 μm and pulverized by a mechanical turbo mill from TURBO KOGYO CO., LTD. to prepare a toner having a weight-average particle diameter of 8.9 μm.

Next, the toner having a weight-average particle diameter of 8.9 μm was classified by a rotational rotor classifier from Hosokawa Micron Corp. to have a weight-average particle diameter of 9.7 μm. Then, 0.8 parts of hydrophobic silica and 0.4 parts of titanium oxide were mixed with the toner and an agglomerate was removed therefrom by a supersonic vibration sieve to prepare a final toner.

### Example 8

After the toner having a weight-average particle diameter of 9.0 μm prepared in Example 7 pulverized by a fluidized-bed jet mill from Hosokawa Micron Corp. to have a weight-average particle diameter of 4.5 μm, the toner was classified by a rotational rotor classifier from Hosokawa Micron Corp. to have a weight-average particle diameter of 5.3 μm. Then, 1.2 parts of hydrophobic silica and 0.6 parts of titanium oxide were mixed with the toner and an agglomerate was removed therefrom by a supersonic vibration sieve to prepare a final toner.

### Comparative Example 2

The toner having a weight-average particle diameter of 8.9 μm prepared in Comparative Example 1 was pulverized by a fluidized-bed jet mill from Hosokawa Micron Corp. and classified by a rotational rotor classifier from Hosokawa Micron Corp. to have a weight-average particle diameter of 5.2 μm. Then, 1.2 parts of hydrophobic silica and 0.6 parts of titanium oxide were mixed with the toner and an agglomerate was removed therefrom by a supersonic vibration sieve to prepare a final toner.

### Example 9

After the toner having a weight-average particle diameter of 9.0 μm prepared in Example 7 pulverized by a supersonic jet mill from Nippon Pneumatic Mfg. Co., Ltd. to have a weight-average particle diameter of 4.3 μm, the toner was classified by a rotational rotor classifier from Hosokawa Micron Corp. to have a weight-average particle diameter of 5.0 μm. Then, 1.2 parts of hydrophobic silica and 0.6 parts of titanium oxide were mixed with the toner and an agglomerate was removed therefrom by a supersonic vibration sieve to prepare a final toner.

### Comparative Example 3

The toner having a weight-average particle diameter of 8.9 μm prepared in Comparative Example 1 was pulverized by a supersonic jet mill from Nippon Pneumatic Mfg. Co., Ltd. and classified by a rotational rotor classifier from Hosokawa Micron Corp. to have a weight-average particle diameter of 5.2 μm. Then, 1.2 parts of hydrophobic silica and 0.6 parts of titanium oxide were mixed with the toner and an agglomerate was removed therefrom by a supersonic vibration sieve to prepare a final toner.

Image tests and evaluations thereof were performed as follows:

(1) Foggy Image

Toner contaminations over background images were observed. Good images without the toner contamination were ∘, usable images with some of the toner contamination were Δ and unusable images were ×.

(2) Image Resolution

Black thin lines were drawn in a width of 1 mm on a blank Image, which were copied to observe how many of the black thin lines can be identified.

(3) Image Density

A reflection density of a black solid image was measured by a Macbeth densitometer.

(4) Granularity

An image density was measured by Nexscan F4100® from HEIDELBERG and the granularity was computed according to Dooley's definition.

Evaluation results of the Examples and Comparative Examples are shown in Table 4.

Tables 1 and 2 show toner materials formulation, Table 2 shows foaming and kneading conditions of the toner materials.

TABLE 1
Toner materials formulation A

| Name of materials | Parts by weight |
|---|---|
| Polyol resin | 100.0 |
| Magenta pigment | 6.0 |
| Zinc salicylate salt | 2.0 |
| Total | 108.0 |

TABLE 2
Toner materials formulation B

| Name of materials | Parts by weight |
|---|---|
| Polyester resin | 100.0 |
| Carbon black | 8.0 |
| Wax | 4.0 |
| Zirconium oxide complex salt | 1.0 |
| Total | 108.0 |

TABLE 3
Results of foamed and kneaded toner materials

| | Unit | Ex. 1 | Ex. 2 | Ex. 3 | Ex. 4 | Ex. 5 | Ex. 6 |
|---|---|---|---|---|---|---|---|
| Toner | — | A | A | A | A | B | B |
| materials | | | | | | | |
| Feeding | Kg/h | 15 | 15 | 15 | 15 | 15 | 15 |
| amount of | | | | | | | |
| the toner | | | | | | | |
| materials | | | | | | | |
| Melting | ° C. | 140 | 140 | 120 | 120 | 140 | 120 |
| zone | | | | | | | |
| temperature | | | | | | | |
| Injection/ | ° C. | 140 | 140 | 120 | 120 | 140 | 120 |
| dispersion | | | | | | | |
| zone | | | | | | | |
| temperature | | | | | | | |
| Temperature | ° C. | 120 | 120 | 90 | 90 | 120 | 90 |
| control zone | | | | | | | |
| temperature | | | | | | | |
| Injection | % by | 3.0 | 1.5 | 3.0 | 1.5 | 3.0 | 3.0 |
| amount of | weight | | | | | | |
| CO₂ | | | | | | | |
| Injection | MPa | 15 | 15 | 15 | 15 | 15 | 15 |
| pressure of | | | | | | | |
| CO₂ | | | | | | | |
| Injection | ° C. | 38 | 38 | 38 | 38 | 38 | 38 |
| temperature | | | | | | | |
| of carbon | | | | | | | |
| dioxide | | | | | | | |
| Temperature control | MPa | 10 | 10 | 10 | 10 | 10 | 10 |
| zone | | | | | | | |
| pressure | | | | | | | |
| The number | pcs/cm³ | 104 to | 105 to | 106 to | 106 to | 105 to | 106 to |
| of air bubbles | | 107 | 107 | 108 | 108 | 107 | 107 |
| A ratio of | % by | 93 | 92 | 90 | 90 | 92 | 91 |
| air bubbles | volume | | | | | | |
| Thickness | μm | 2 to 5 | 2 to 5 | 3 to 8 | 4 to 9 | 5 to 15 | 6 to 15 |
| of air bubble film | | | | | | | |

TABLE 4
Toner pulverizability and image test results

| | | | Com. | | Com. | | Com. |
|---|---|---|---|---|---|---|---|
| | Unit | Ex. 7 | Ex. 1 | Ex. 8 | Ex. 2 | Ex. 9 | Ex. 3 |
| Weight- | μm | 60 | 250 | 60 | 250 | 60 | 250 |
| average | | | | | | | |
| particle | | | | | | | |
| diameter after | | | | | | | |
| crushed | | | | | | | |
| Weight- | μm | 9.0 | 8.9 | 4.5 | 4.5 | 4.3 | 4.3 |
| average | | | | | | | |
| particle | | | | | | | |
| diameter after | | | | | | | |
| Pulverized | | | | | | | |
| Weight- | μm | 9.8 | 9.7 | 5.3 | 5.2 | 5.0 | 5.2 |
| average | | | | | | | |
| particle | | | | | | | |
| diameter after | | | | | | | |
| Classified | | | | | | | |
| Pulverizability | Kg/h | 30 | 18 | 10 | 6 | 9 | 5 |
| Foggy image | — | ◯ | ◯ | ◯ | ◯ | ◯ | ◯ |
| Image | — | 5.7 | 5.8 | 7 | 6.9 | 7.5 | 7 |
| resolution | | | | | | | |
| Image density | — | 1.50 | 1.49 | 1.47 | 1.48 | 1.45 | 1.47 |
| Granularity | — | 1.0 | 1.2 | 0.4 | 0.4 | 0.3 | 0.4 |

This document claims priority and contains subject matter related to Japanese Patent Application No. 2003-140977 filed on May 19, 2003, the entire contents of which are hereby incorporated herein by reference.

Having now fully described the invention, it will be apparent to one of ordinary skill in the art that many changes and modifications can be made thereto without departing from the spirit and scope of the invention as set forth therein.

1. A foaming kneader comprising:
an injection and dispersion device configured to inject and disperse a supercritical fluid into a mixture comprising a binder resin and a colorant under pressure upon application of heat to said mixture to uniformly disperse the supercritical fluid in the mixture.

2. A foaming kneader comprising:
a continuous kneader configured to knead a mixture comprising a binder resin and a colorant under pressure upon application of heat to said mixture to prepare a kneaded mixture;
a feeder configured to feed the kneaded mixture at a predetermined feed rate; and
an injection and dispersion device configured to inject and disperse a supercritical fluid in the mixture fed by the feeder under pressure upon application of heat to said mixture to uniformly disperse the supercritical fluid in the mixture.

3. A foaming kneader comprising:
a kneader configured to preliminarily knead a mixture comprising a binder resin and a colorant under pressure upon application of heat to said mixture to prepare a kneaded mixture;
a cooler configured to cool the preliminarily kneaded mixture by rolling;
a crusher configured to crush the preliminarily kneaded mixture to prepare a chip of said mixture; and
an injection and dispersion device configured to inject and disperse a supercritical fluid in the chip under pressure upon application of heat to said chip to uniformly disperse the supercritical fluid in the chip.

4. A mixture comprising:
a binder resin;
a colorant; and
air bubbles, said air bubbles having a density from 104 to 108 pieces/cm³ and constituting from 65 to 95% of said mixture by volume.
